(19) United States
(12) Patent Application Publication
(10) Pub. No.: US 2010/0282584 A1
(43) Pub. Date: Nov. 11, 2010

(54) ZIPPER SWITCH FOR DC MOTOR OF CEILING FAN

(76) Inventor: Teng-san TSENG, Wufong Township (TW)

Correspondence Address: Wang Law Firm, Inc., 4989 Peachtree Parkway,, Suite 200, Norcross, GA, 30092, US

(21) Appl. No.: 12/140,894

(22) Filed: Jun. 17, 2008

(51) Int. Cl. H01H 17/18

(52) U.S. Cl. 200/331; 200/336

(57) ABSTRACT

A zipper switch for the DC motor of a ceiling fan includes upper and lower cases matching with each other. The upper case is disposed with a driving disk, an elastic element, and a zipper that can rotates the driving disk in one direction. The driving disk is urged by the elastic element to rotate in the opposite direction. The driving disk has a pushing part for pushing a rotating block pivotally disposed in the lower case. The rotating block is disposed with a metal plate with a plurality of electrical contacts. Both sides of the lower case are disposed with a conductive chip, respectively. When the pushing part rotates the rotating block, each electrical contact has intermittent electrical contacts with the conductive chips to start the DC motor.

### BACKGROUND OF THE INVENTION

1. Field of Invention

The invention relates to a zipper switch for the DC motor of a ceiling fan and, in particular, to a zipper switch that provides an instantaneous electrical current.

2. Related Art

Normally, a DC ceiling fan is provided with continuous electrical power. The AC power is also used to start or change the rotation speed of the ceiling fan. FIG. 5 shows a conventional zipper switch used to provide continuous electrical power. It consists of an upper case 71 and a lower case 72 that connect with each other. The upper case 71 is provided with a driving disk 73, a zipper 74, a torsion spring 75, and a pressure cover 76. The driving disk 73 and the torsion spring 75 are pivotally disposed at the center of the upper base 71. The driving disk 73 connects to the zipper 74. There are four pushing parts 76 with slant surface protruded from the middle of one side of the driving disk 73. By pulling the zipper 74, the driving disk 73 drives the pushing parts 76 to rotate in one direction with respect to the center of the upper base 71, forwarding by the distance of one pushing part. On the contrary, when the zipper 74 is released, the torsion spring 75 enables the pushing parts 76 to rotate in the other direction, backing by the distance of one pushing part 76.

The lower case 72 has a rotating block 77 and two conductive chips 78 connected with wires. The rotating block 77 is pivotally disposed at the center in the lower case 72. The rotating block 77 has a metal plate 79, both sides of which are formed with conductive contacts 81. The outer side of the rotating block 77 is further formed with four passive parts 83 corresponding to the pushing parts 76. The conductive chips 78 are disposed in the vicinity of the rotating block 77. Therefore, the pushing force produced when the pushing parts 76 rotates forward can push the passive parts 83, rotating the passive parts 83 in a single direction by a quarter circle. Please further refer to FIG. 6A. After pulling and releasing the zipper 74 for the first time, the two conductive chips 78 touch against the conductive contacts 81 on the metal plate 78 of the rotating block 77, establishing the ON mode. When the zipper 74 is pulled and released again, as shown in FIG. 6B, the two conducive chips 78 directly touch one side of the rotating block 77 instead of the conductive contacts 81, establishing the OFF mode. The two conductive contacts 81 and conductive chips 78 on the metal plate 79 thus switch between the ON and OFF modes.

However, the zipper switch is used in an AC motor. Therefore, each time the zipper 74 is pulled and released, the metal plate 77 and the conductive chips become conductive or non-conductive. For a DC motor, its start is triggered by an instantaneous electrical current. The disclosed zipper switch for an AC motor is used to provide continuous electrical power to establish the ON and OFF modes. Consequently, it cannot be directly used as the zipper switch for a DC motor.

Please refer to FIG. 7. It is a zipper switch for the DC motor of a ceiling fan invented by the inventor of the present invention. It includes an upper case 91 and a lower case 92 that match with each other. The upper case 91 is pivotally disposed with a driving disk 93, a torsion spring 94, and a zipper 95 connected to the driving disk 93. One side of the driving disk 93 has a connecting part 96, a fixed metal plate 97, and contacts 98 on its both sides. The lower case 92 accommodates the connecting part 96. A conductive chip 99 is disposed in the lower case 92 in the vicinity of each side of the contact 98 of the metal plate 97. The rotation of the driving disk 93 enables instantaneous contacts of the contacts 98 on the metal plate 97 with the conductive chips 99 in the lower case 92, producing an instantaneous electrical current.

Nevertheless, although it can be used in a DC motor, the above-mentioned zipper switch still has the following problems:

1. As shown in FIG. 8A, the starting method is to pull the zipper 95 so that the two contacts 98 on the metal plate 97 have instantaneous contacts with the corresponding conductive chips 99. Once the zipper 95 is released, as shown in FIG. 8B, the driving disk 93 is rotated backwards under the elastic force of the torsion spring 94, restoring the OFF mode. Since this starting method is achieved by urging the contacts 98 on both sides of the metal plate 97 against the conductive chips 99, erosions often occur between them.

2. Moreover, when a user pulls the zipper 95 to start a DC motor, the contacts 98 on the connecting part 96 of the driving disk 93 rotate simultaneously and touch with the two conductive chips 99. There is no sound or anything that makes the user feel about the ON and OFF of the switch. Therefore, a normal user may think that the DC motor is not started even though it is already turned on.

### SUMMARY OF THE INVENTION

An objective of the invention is to provide a zipper switch for the DC motor of a ceiling fan in which, with a plurality of conductive contacts formed symmetrically and at equal angles, the conductive contacts on the rotating block can have intermittent electrical contacts with the conductive chips in the lower case as the pushing part rotates the rotating block. This produces instantaneous electrical currents.

Another objective of the invention is to provide a zipper switch for the DC motor of a ceiling fan, which has uniform contacts between the conductive contacts and the conductive chips so that erosions can be reduced. Therefore, the lifetime of the conductive contacts is longer.

Yet another objective of the invention is to provide a zipper switch for the DC motor of a ceiling fan that gives the user a specific feeling about the start or rotation speed change. Therefore, it will not cause any illusion to the user.

To achieve the above-mentioned objectives, the disclosed zipper switch for the DC motor of a ceiling fan includes an upper case, a rotating block, and a lower case.

The upper case is pivotally disposed with a driving disk, an elastic element, a zipper, and a pressure cover. The elastic element urges the driving disk by its one end and the upper case by its other end. The zipper is connected to the driving disk and drives the driving disk to rotate in a single direction. The driving disk is urged by the elastic element to rotate in the opposite direction. The pressure cover covers the driving disk on one side, thereby positioning the elastic element and the driving disk in the upper case. A pushing part with a plurality of slant surfaces extends from the center of the driving disk outward.

The rotating block is formed on its one end by a plurality of passive parts corresponding to the slant surfaces of the pushing part. The slant surface engages with the passive part in one direction. It further drives the rotating block to perform a circular rotation in steps. The side surface of each passive part is protruded outward with a protruding part. The rotating block is mounted with a metal plate. The metal plate is formed with a plurality of conductive contacts of equal heights symmetrically and at equal angles along the edge of the rotating block. The conductive contacts and the protruding parts are disposed alternately.

The lower case has an accommodating space at its center for the rotating block to be disposed pivotally therein. A conductive chip is disposed on each side of the rotating block in the lower case. When the pushing part drives the rotating block to rotate, the conductive contacts on the rotating block can have intermittent electrical contacts with the conductive chips in the lower case.

The disclosed zipper switch is normally in the OFF mode. When the pushing part drives the rotating block to rotate, the two conductive chips during the rotation stroke have temporary electrical contacts with the conductive contacts changing from the original OFF mode (supported by the protruding parts on the side of the passive part) to the ON mode, and then to the OFF mode again. The above-mentioned intermittent electrical contacts can also generate an instantaneous electrical current to start the DC motor.

### BRIEF DESCRIPTION OF THE DRAWINGS

The invention will become more fully understood from the detailed description given herein below illustration only, and thus is not limitative of the present invention, and wherein:

FIG. 1 is a three-dimensional exploded view of the invention;

FIG. 2A is a schematic view showing that the disclosed zipper switch is in its ON mode;

FIG. 2B is a schematic view showing that the conductive chips are pushed by the protruding parts on the side of the passive part, establishing a temporary OFF mode;

FIG. 3A shows that the slant surfaces on the pushing part of the invention are pushed by the elastic element to slide along the passive part of the rotating block;

FIG. 3B shows that the slant surfaces on the pushing part of the invention are engaged in a single direction with the passive part of the rotating block;

FIG. 4A shows that the zipper switch is in the OFF mode according to another embodiment of the invention;

FIG. 4B shows that the zipper switch is temporarily in the ON mode due to the temporary contacts between the conductive chips and the conductive contacts according to another embodiment of the invention;

FIG. 5 is a three-dimensional exploded view of the zipper switch for an AC motor in the prior art;

FIG. 6A shows the action of the conventional zipper switch for an AC motor in the ON mode;

FIG. 6B shows the action of the conventional zipper switch for an AC motor in the OFF mode;

FIG. 7 is a three-dimensional view of the zipper switch for a DC motor in the prior art;

FIG. 8A shows the action of the conventional zipper switch for a DC motor in the ON mode; and

FIG. 8B shows the action of the conventional zipper switch for a DC motor in the OFF mode.

### DETAILED DESCRIPTION OF THE INVENTION

The present invention will be apparent from the following detailed description, which proceeds with reference to the accompanying drawings, wherein the same references relate to the same elements.

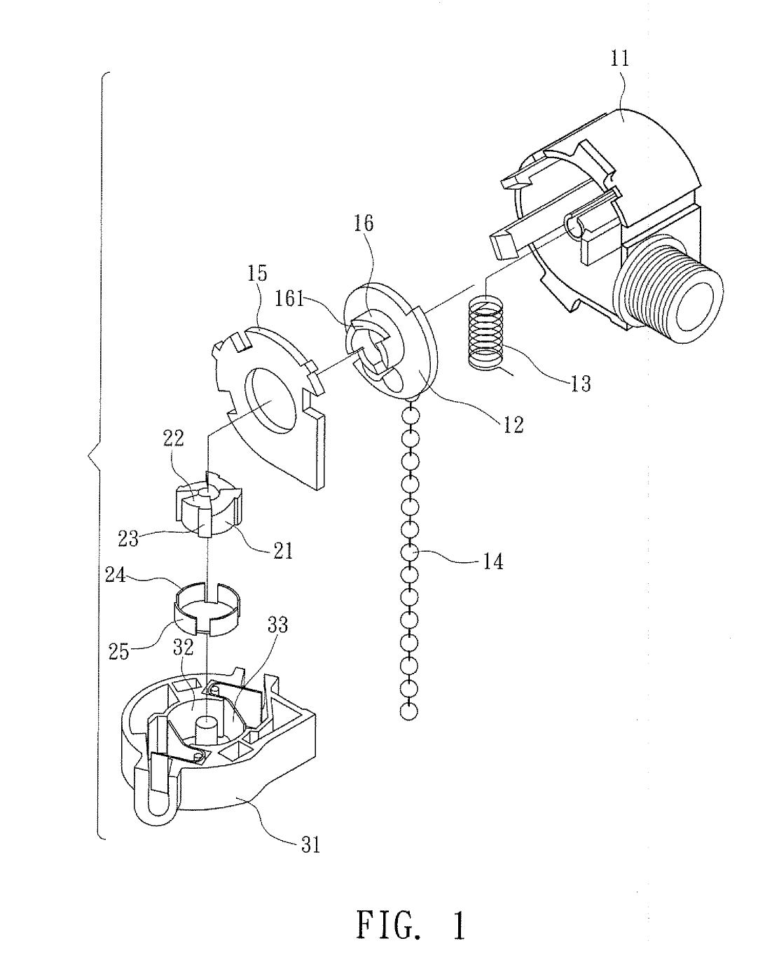

Please refer to FIG. 1. The invention provides a zipper switch for the DC motor of a ceiling fan. It mainly includes an upper case 11, a rotating block 21, and a lower case 31.

The upper case 11 is pivotally disposed with a driving disk 12, an elastic element 13, a zipper 14, and a pressure cover 15. The elastic element 13 is disposed on one side of the driving disk 12. In this embodiment, the elastic element 13 is a torsion spring. The elastic element 13 urges against one side of the driving disk 12 by its one end and the central axis of the upper case 11 by its other end. The zipper 14 is connected to the driving disk 12 to rotate the driving disk 12 in a single direction. The driving disk 12 is pushed by the elastic force provided by the driving disk 12 to perform a rotation in the opposite direction. The pressure cover 15 covers the driving disk 12 on one side, thereby positioning the elastic element 13 and the driving disk 12 in the upper case 11. A pushing part 16 extends from the central portion of the driving disk 12 on the side opposite to the elastic element and goes through the pressure cover 15. The end surface of the pushing part 16 is formed with four slant surfaces 161. When the zipper 14 is pulled, the driving disk 12 rotates with respect to the upper case 11, driving the pushing part 16 to rotate in one direction. On the other hand, when the zipper 14 is released, the elastic restoring force provided by the elastic element 13 drives the pushing part 16 to rotate in the opposite direction.

The rotating block 21 is formed on its one end with fourth passive parts 22 corresponding to the slant surfaces 161 on the pushing part 16. The slant surfaces 161 are engaged with the passive parts 22 in a single direction. The rotating block 21 is allowed to perform a circular motion in steps in a single direction. The side of each passive part 22 is formed with a protruding part 23 outward. The rotating block 21 is mounted with a metal plate 24. The metal plate 24 is formed with four conductive contacts 25 of equal height symmetrically and at equal angles along the edge of the rotating block 21. Each of the conductive contacts 25 and the protruding parts 23 are disposed alternately.

The lower case 31 combines with the upper case 11. The central portion of the lower case 31 is an accommodating space 32 for the rotating block 21 to be disposed pivotally therein. Each side of the rotating block 21 in the lower case 31 is disposed with a conductive chip 33. Each of the conductive chips 33 is connected with a corresponding wire (not shown) so that an electrical current flows through the wire when the corresponding conductive contact 25 and the conductive chip 33 have an electrical contact.

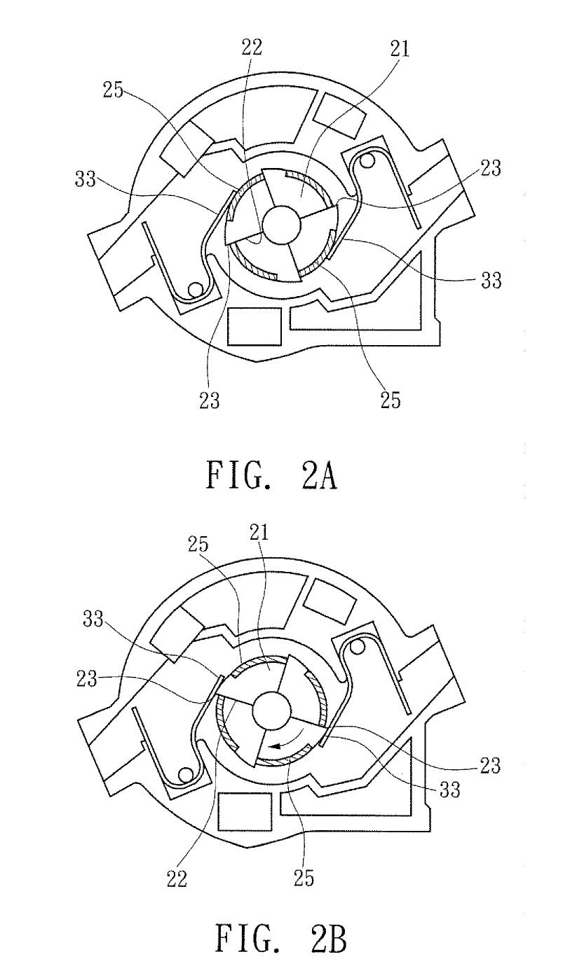

As shown in FIG. 2A, the two conductive contacts 25 and the two conductive chips 33 in this embodiment are in touch, forming a constant ON state. When the user pulls the zipper 14 to rotate the pushing part 16, the passive part 22 is pushed in a single direction. The rotating block thus rotates in a single direction by a quarter circle. When the user releases the zipper 14, the driving disk 12 is pushed under the restoring elastic force of the elastic element 13 to return to its original position. As the pushing part 16 of the driving disk 12 is engaged with its slant surfaces 161 in a single direction on the passive parts 22 of the rotating block 21, the rotating block 21 is not driven to rotate. Therefore, each of the conductive contacts 25 has uniform contacts with the two conductive chips 33, reducing possible erosions between them. The lifetime of the conductive contacts 25 can thus be extended.

When the pushing part 16 drives the rotating block 21 to rotate by a quarter circle, the conductive contacts 25 and the conductive chips 33 in the rotation stroke change form the original ON state (FIG. 2A) to the OFF state temporarily (FIG. 2B), as they are pushed by the side protruding parts 23 of the passive part 22. Afterwards, they are in contact again and return to the ON state (FIG. 2A). The above-mentioned intermittent electrical contacts produce an instantaneous signal to start the DC motor.

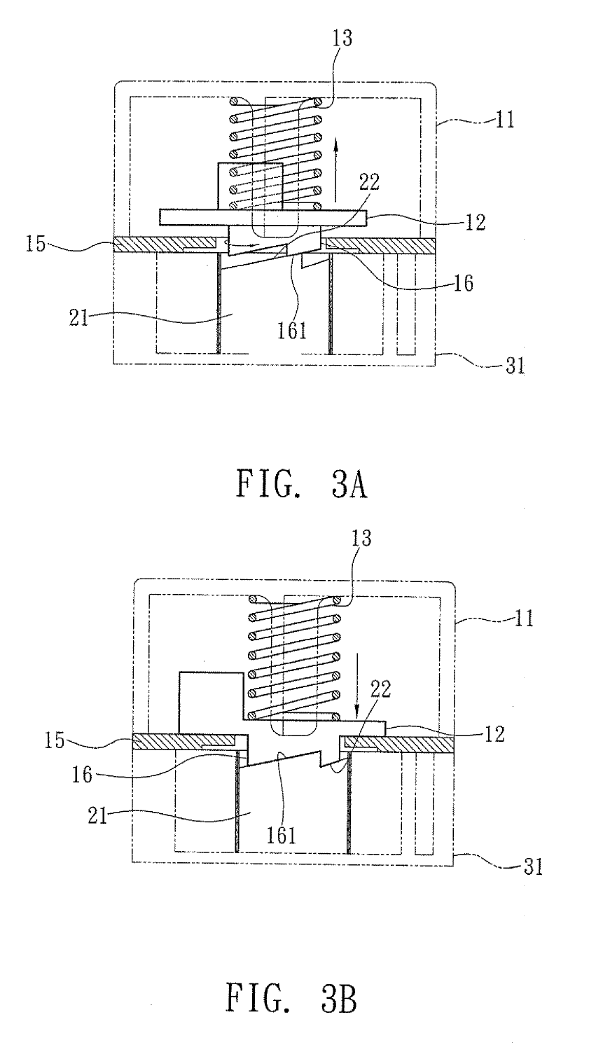

Please refer to FIG. 3A. When the zipper 14 is released so that the driving disk 12 is pushed under the elastic force of the elastic element 13 to rotate in the other direction, the slant surfaces 161 on the pushing part 16 of the driving disk 12 are pushed by the elastic element 13 to slide along the passive parts 22 on the rotating block 21. At the same time, the driving disk 12 gradually pushes the elastic element 13 to contract toward the inside of the upper case 11. When the slant surfaces 161 on the pushing part 16 of the driving disk 12 slide to the end of the passive part 22, as shown in FIG. 3B, the pushing part 16 experiences the downward restoring elastic force produced by the elastic element 13 and engages in a single direction with the passive part 2 of the rotating block 21 again. With the collision feeling and sound produced by the engagement between the slant surfaces 161 and the passive parts 22, the user can clearly know that the DC motor is started without any confusion.

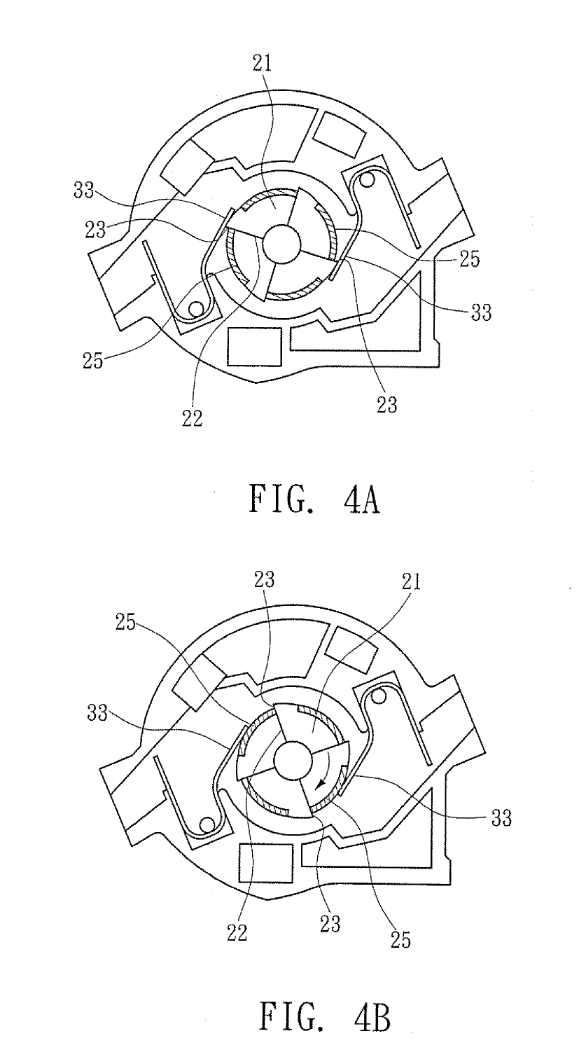

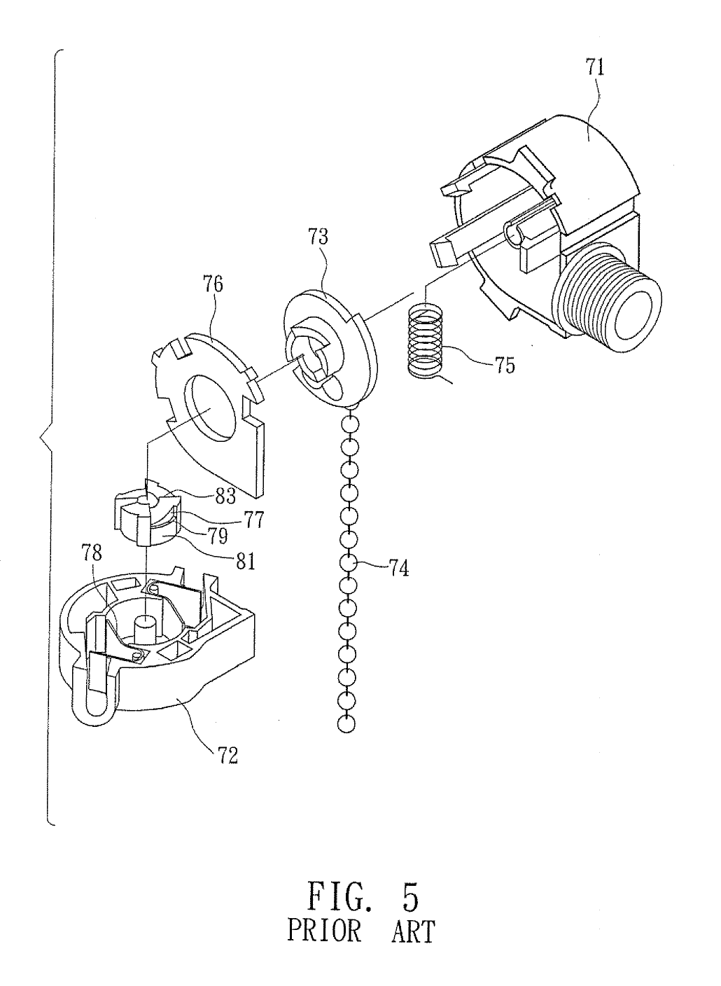

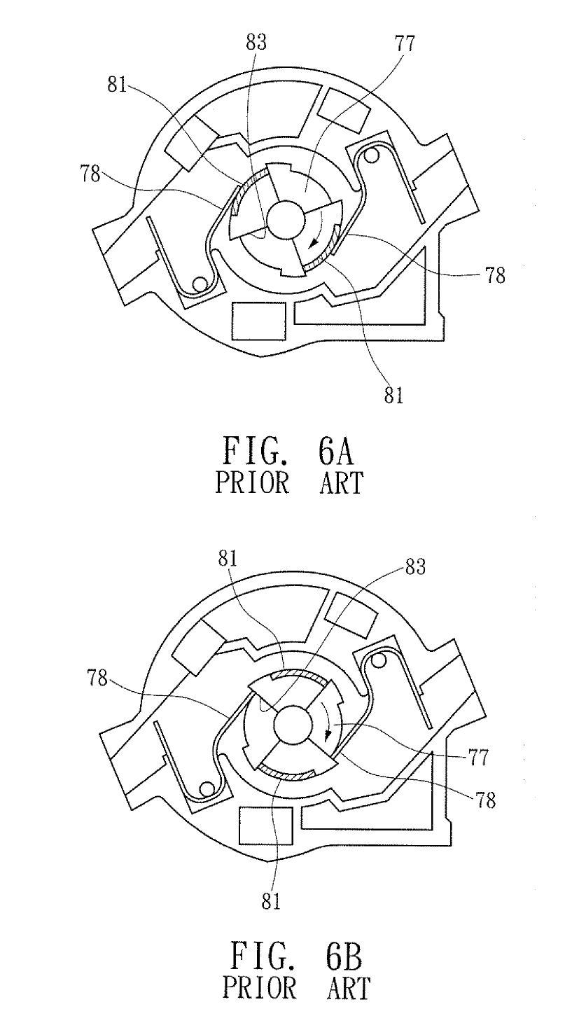

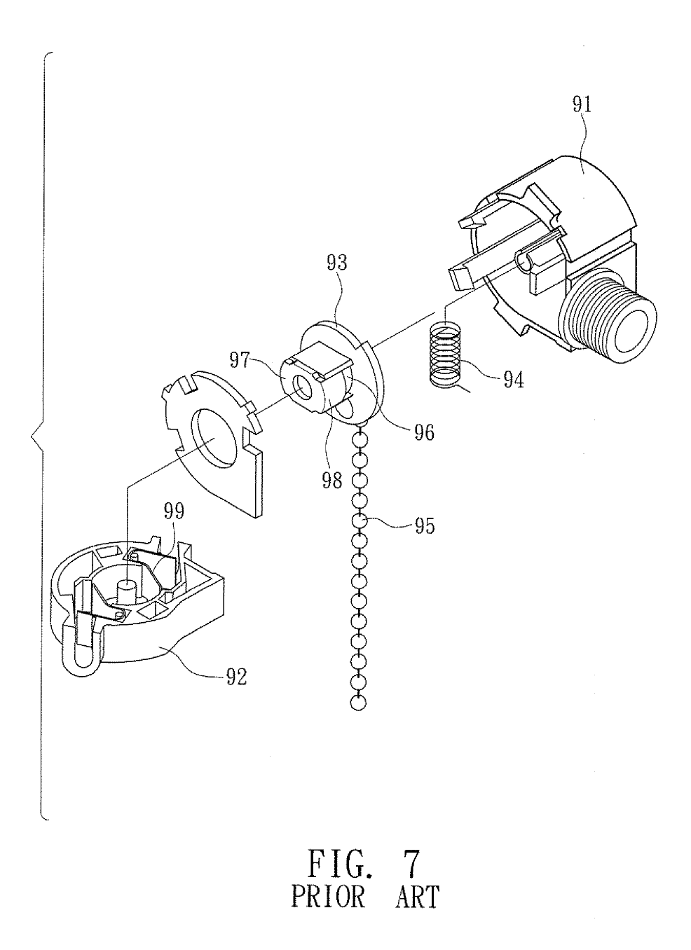

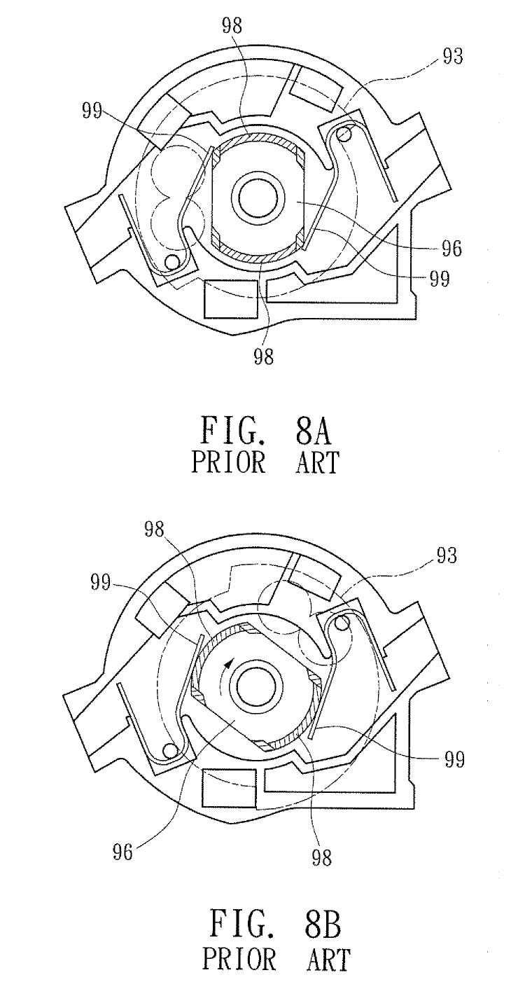

FIG. 4A shows another embodiment of the invention. It discloses a zipper switch that is constantly in the OFF mode. It is different from the above embodiment only in that: the two conductive chips 33 are pushed by the side protruding parts 23 of the passive parts 22 so that they do not have any contact with the conductive contacts 25. Therefore, it is constantly in the OFF state. When the pushing part 16 drives the rotating block 21 to rotate by a quarter circle, the two conductive chips 33 have temporary electrical contacts with the conductive contacts 25 during the rotation stroke, establishing the ON state (FIG. 4B), and then to the OFF state (FIG. 4A) as they are separated by the side protruding parts 23 of the passive parts 22 again. The above-mentioned intermittent electrical contacts can also produce instantaneous signals to start the DC motor.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A zipper switch for the DC motor of a ceiling fan, comprising:
an upper case, wherein a driving disk is pivotally disposed therein, an elastic element is disposed between the driving disk and the upper case, a zipper is disposed on the driving disk for rotating the driving disk in one single direction, the driving disk is urged by the elastic element to rotate in the opposite direction, the driving disk is formed with a pushing part having a plurality of slant surfaces, one end of a rotating block is formed with a passive part corresponding to the slant surfaces so that the slant surfaces are engaged with the passive part and the rotating block is free to rotate in steps in one direction;
a lower case matching with the upper case, wherein an accommodating space is formed in the lower case for accommodating pivotally the rotating block, and each side of the lower case in the vicinity of the rotating block is disposed with a conductive chip;
wherein the rotating block is disposed with a metal plate that has four electrical contacts separated by same angle along the edge of the rotating block, and each electrical contact on the rotating block and the conductive chips in the lower case have intermittent electrical contacts.

2. A zipper switch for the DC motor of a ceiling fan as in claim 1, wherein a pressure cover covers one side of the driving disk, thereby positioning the elastic element and the driving disk inside the upper case, and the pushing part of the driving disk penetrates through the middle of the pressure cover and extends outwards.

3. A zipper switch for the DC motor of a ceiling fan as in claim 1, wherein each of the passive parts is protruded outward by a protruding part from its side and the electrical contacts and the protruding parts are disposed alternately.

4. A zipper switch for the DC motor of a ceiling fan as in claim 3, wherein each of the electrical contacts touches the two conductive chips, forming a constant on state, and the electrical contacts and the conductive chips change from the on state to an off state as they are temporarily pushed to form a broken circuit during rotation.

5. A zipper switch for the DC motor of a ceiling fan as in claim 3, wherein the two conductive chips are pushed by the side protruding part of the passive part so that they do not touch the electrical contacts, forming a constantly off state, and the two conductive chips change from the off state to an on state as they temporarily touch the electrical contacts during rotation.

6. A zipper switch for the DC motor of a ceiling fan as in claim 1, wherein the end surface of the pushing part is fowled with four slant surfaces and the rotating block is formed with four passive parts corresponding to the slant surfaces and, when the pushing part is drive to rotate, the rotating block is pushed in a single direction by a quarter circle, and the rotating block is not driven to rotate when the driving disk is urged by the elastic element to perform its return stroke.

7. A zipper switch for the DC motor of a ceiling fan as in claim 6, wherein when the driving disk is urged by the elastic element to performing its return stroke, the slant surfaces on the pushing part thereof is pushed by the elastic element to slide along the passive parts of the rotating block, contracting the elastic element, and when the slant surfaces on the pushing part of the driving disk slides to the end of the passive part, the pushing part collides with the rotating block as it is pressed downward by the elastic element, engaging with the passive part of the rotating block in a single direction again.

8. A zipper switch for the DC motor of a ceiling fan as in claim 1, wherein the four electrical contacts formed on the metal plate are of equal heights and symmetric.
